(19) United States
(12) Patent Application Publication
(10) Pub. No.: US 2009/0018712 A1
(43) Pub. Date: Jan. 15, 2009

(54) METHOD AND SYSTEM FOR REMOTELY MONITORING AND CONTROLLING A VEHICLE VIA A VIRTUAL ENVIRONMENT

(76) Inventors: Jerry Richard Duncan, Bettendorf, IA (US); Brandon James Newendorp, Cedar Falls, IA (US)

Correspondence Address: DEERE & COMPANY, ONE JOHN DEERE PLACE, MOLINE, IL, 61265, US

(21) Appl. No.: 11/777,312

(22) Filed: Jul. 13, 2007

(51) Int. Cl. G05D 1/00; G06F 3/14

(52) U.S. Cl. 701/2; 701/23

(57) ABSTRACT

A method and system for remotely monitoring and controlling a vehicle comprises a remote user interface for establishing a first model of a work area representative of the real world or an environment around the vehicle. Sensors collect data on a second model of the work area. Each of the sensors is associated with the vehicle. An evaluator determines a material discrepancy between the first model and the second model. A transmitter transmits the material discrepancy to a user remotely separated from the vehicle. A display module displays data from at least one of the first model, the second model and the material discrepancy to a user for resolution or classification of the discrepancy.

### FIELD OF THE INVENTION

This invention relates to a method and system for remotely monitoring and controlling a vehicle via a virtual environment.

### BACKGROUND OF THE INVENTION

A remote controlled or tele-operated vehicle may be equipped with a camera or another imaging device to collect one or more images around the vehicle. The collected images may be transmitted to an operator, who remotely controls the vehicle. Further, the collected images may be displayed as a conventional two-dimensional representation of at least a portion of the environment around the vehicle.

A conventional two-dimensional representation of an environment around a vehicle may present problems to an operator who seeks to control remotely the vehicle. For example, conventional two dimensional images may provide low or reduced situational awareness because an operator is only able to view selected portions or disjointed segments about the entire operational environment. The operator may experience difficulty in controlling or maneuvering the vehicle based on the operator's extrapolation of three-dimensional information from two-dimensional data about the environment. For example, the operator may become disoriented as to the vehicular position with respect to the operational environment. Further, the operator may incorrectly integrate data from multiple two dimensional representations of the environment. Thus, there is a need for facilitating improved remote control of a vehicle via a virtual environment.

### SUMMARY OF THE INVENTION

A method and system for remotely monitoring and controlling a vehicle comprises a remote user interface for establishing a first model of a work area representative of the real world or an environment around the vehicle. Sensors collect data on a second model of the work area. Each of the sensors is associated with the vehicle. An evaluator determines a material discrepancy between the first model and the second model. A transmitter transmits the material discrepancy to a user remotely separated from the vehicle. A display module displays data from at least one of the first model, the second model and the material discrepancy to a user for resolution or classification of the discrepancy.

### BRIEF DESCRIPTION OF THE DRAWINGS

FIG. 1 is a block diagram of a system for remotely monitoring and controlling a vehicle via a virtual environment.

FIG. 2 is a block diagram of an illustrative example of a remote user interface for the system of FIG. 1.

FIG. 3 is a flow chart of one embodiment of a method for remotely monitoring and controlling a vehicle via a virtual environment.

FIG. 4 is a flow chart of another embodiment of a method for remotely monitoring and controlling a vehicle via a virtual environment.

FIG. 5 is a flow chart of yet another embodiment of a method for remotely monitoring and controlling a vehicle via a virtual environment.

FIG. 6 is a flow chart of still another embodiment of a method for remotely monitoring and controlling a vehicle via a virtual environment.

### DESCRIPTION OF THE PREFERRED EMBODIMENT

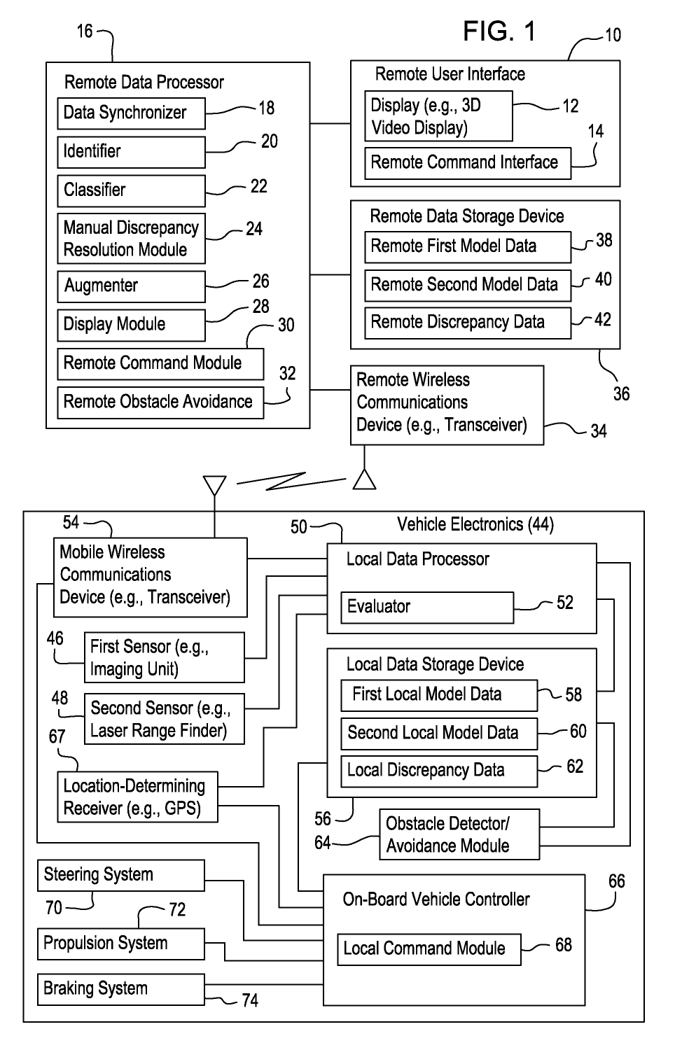

In accordance with one embodiment, FIG. 1 comprises a remote user interface 10, a remote data storage device 36, and a remote wireless communications device 34 coupled to a remote data processor 16. The remote wireless communications device 34 communicates with the vehicle electronics 44 via a mobile wireless communications device 54.

The vehicle electronics 44 comprises a first sensor 46, a second sensor 48, a mobile or local wireless communications device 54, a local data storage device 56, an obstacle detector/avoidance module 64, and an on-board vehicle controller 66 that can communicate with a local data processor 50. The lines that interconnect the local data processor 50 with the other foregoing components may represent one or more physical data paths, logical data paths, or both. A physical data path may represent a databus, whereas a logical data path may represent a communications channel over a databus or other communications path, for example.

The on-board vehicle controller 66 may communicate with the local data processor 50, a steering system 70, a propulsion system 72, and braking system 74. Further, the on-board vehicle controller 66 may generate control data or control signals for one or more of the following devices or systems: the steering system 70, the propulsion system 72, and the braking system 74. The on-board vehicle controller 66 may comprise a local command module 68 that may control the vehicle in absence of remote commands generated by a user or by a remote user interface 10, for example.

The first sensor 46 may comprise an imaging unit (e.g., camera) for capturing images of an environment around the vehicle. The imaging unit may capture stereo images, monocular images, color images, black and white images, infra-red images, or monochrome images, for example. The imaging unit may support capturing of video or a series of images representative of the relative motion of the vehicle with respect to one or more objects in the environment around the vehicle.

The second sensor 48 may comprise a laser range finder, a scanning laser, a ladar device, a lidar device, a radar device, an ultrasonic sensor, or another device for determining the range or distance between the second sensor 48 and one or more objects in the environment. In an alternate embodiment, the second sensor 48 may comprise a camera, a chemical detector, an electromagnetic signal detector (e.g., a radio frequency receiver), a motion detector, an infrared detector, a smoke detector, a thermal sensor, a chemical detector, an ionizing radiation detector (e.g., for detecting alpha, beta or gamma ionizing radiation), a temperature detector, an infrared detector, or another detector. The radiation detector may comprise a Geiger counter, a scintillation detector, a semiconductor detector, an electrometer, or a dosimeter, for example. The chemical detector may comprise a fluid or gas analyzer that uses one or more reagents, a spectrometer, or a spectroscopic analyzer to identify the composition or chemical constituents of an air, fluid or gas sample.

As illustrated in FIG. 1, the local data processor 50 comprises an evaluator 52. The local data processor 50 may store, retrieve and access information from a local data storage device 56. The local data storage device 56 may store local first model data 58, local second model data 60, and local discrepancy data 62.

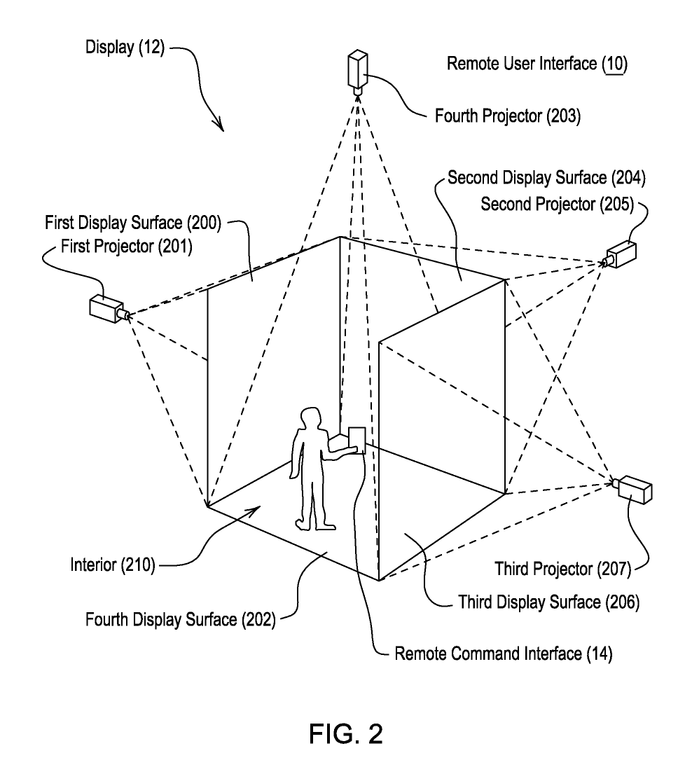

The remote user interface 10 comprises a display 12 and a remote command interface 14. The display 12 (e.g., three-dimensional video display) is arranged to display two dimensional images or three dimensional representations of images observed at the vehicle electronics 44, or the sensors (46, 48). The remote command interface 14 may comprise a keyboard, a keypad, a pointing device (e.g., mouse), a joystick, a steering wheel, a switch, a control panel, a driving simulator or another user interface for human interface to control and/or monitor the vehicle, its status or operation. In one embodiment, the remote command interface 14 may be embodied as a handheld or portable control device that the user may interact with while immersed in or observing a virtual environment associated with the display 12. The remote command interface 14 may communicate with the remote data processor via a communications link (e.g., a transmission line, a wireless link or an optical link suitable for short-range communications). An illustrative example of the remote user interface 10 is described later in more detail in conjunction with FIG. 2.

The remote user interface 10 and the remote data processor 16 facilitate the establishment of a virtual environment. A virtual environment refers to a representation or model of a real world environment around the vehicle from one or more perspective or reference frames. The terms virtual environment and modeled environment shall be regarded as synonymous throughout this document. The virtual environment may comprise a representation of the real world that is displayed to user or operator to facilitate control and/or monitoring of the vehicle.

The remote user interface 10 may project or display a representation or model (e.g., virtual environment) of the actual environment of the vehicle from a desired perspective. In one embodiment, the virtual environment may comprise a three dimensional model or representation. Although the desired perspective may be from a cabin, cockpit, or operator station of the vehicle, the desired perspective may also be from above the vehicle or above and behind the vehicle. At least a portion of the virtual environment is generally pre-established or collected prior to the operation of the vehicle by a survey of the real world environment (e.g., via the vehicle electronics, survey equipment, a topographic survey, satellite imagery, aerial imagery, topographical databases or otherwise). Such pre-established or collected data on the environment may be referred to as a priori environmental information. The perspective or view of the operator may be referred to as tethered view to the extent that the display 12 shows a perspective within a maximum defined radius (e.g., spherical radius) of the vehicle.

The remote data processor 16 comprises a data synchronizer 18, an identifier 20, a classifier 22, a manual discrepancy resolution module, an augmenter 26, a display module 28, a remote command module 30 and a remote obstacle avoidance 32 module. The remote data processor 16 facilitates the definition, establishment, update, and revision of the virtual environment or its underlying data structure and model. The virtual environment may be defined in accordance with various techniques which may be applied alternatively, cumulatively, or both. In accordance with a first technique, the remote data processor 16 or the display module 28 defines the virtual representation by surface points or cloud maps on three dimensional representations (e.g., of objects, the ground and/or terrain) within the virtual environment. For example, the surface points may be located at the corners or vertexes of polygonal objects. Under a second technique, remote data processor 16 or the display module, first, establishes surface points or cloud maps and, second, transforms the established surface points or cloud maps into geometric representations of the environment and objects in the environment. Under a third technique, the surface points, cloud maps, or geometric representations may be processed to have a desired appearance, including at least one of surface texture, appearance, lighting, coloring, or shading. Under a fourth technique, the classifier 22 may classify objects based on the detected shape and size of an object matching a reference shape, reference size or reference profile.

First model data refers to a first version (e.g., initial version or initial model) of the virtual environment, whereas second model data refers to a second version (e.g., subsequent version or subsequent model) of the virtual environment. Although the first model data and the second model data may generally refer to sequentially collected or observed data in which the first model data is collected or observed in a time interval prior to that of the second model data, the first model data and the second model data may be collected simultaneously from different sensors or simultaneously from different perspectives within the environment. If the first version and the second version are identical for a time interval, no discrepancy data exists for the time interval; either the first model data or the second model data may be used as the final version or revised version for that time interval. However, if the first version and the second version of the model data are different for a time interval, a discrepancy exists that may be described or defined by discrepancy data.

The first model data, the second model data, and the discrepancy data that is stored in the remote data storage device 36 is referred to with the prefix, “remote.” The remote data storage 36 is generally separated from the position of the vehicle and the vehicle electronics 44. The remote data storage device 36 stores or manages remote first model data 38, remote second model data 40, and remote discrepancy data 42. The remote first model data 38, the remote second model data 40, and the remote discrepancy data 42 have the same general definitions, attributes and characteristics as the first model data, the second model data, and the discrepancy data, respectively.

The first model data, the second model data, and the discrepancy data that is stored in the local data storage device 56 is referred to with the prefix, “local.” The local data storage device 56 stores or manages local first model data 58, local second model data 60, and local discrepancy data 62. The local first model data 58, the local second model data 60, and the local discrepancy data 62 have the same general definitions, attributes and characteristics as the first model data, the second model data, and the discrepancy data, respectively.

A vehicle version of the virtual environment or model of the real world is stored in the vehicle electronics 44, whereas a remote version of the virtual environment or model of the real world is stored in the remote electronics (e.g., remote data processor 16 and the remote data storage device 36). The vehicle version and the remote version are generally periodically synchronized to each other via the communications link between the remote wireless communications device 34 and the mobile wireless communications device 54.

The first sensor 46, the second sensor 48, or both provide sensor data or occupancy grid data based on survey of a real world or actual environment. The vehicle electronics 44, the local data processor 50 and/or the remote data processor 16 may convert the sensor data or occupancy grid into first model data, second model data and discrepancy data. The first model data, the second model data and the discrepancy data may be displayed in a virtual environment observed by a user at the remote user interface 10. As the first sensor 46 and the second sensor 48 collect new or updated sensor data, the virtual environment is periodically or regularly updated or synchronized. One or more of the following data may be aligned or synchronized at regular or periodic intervals: (1) the first model data and the second model data, (2) the remote model data and the local model data, (3) the remote discrepancy data and the local discrepancy data, (4) the remote first model data and the remote second model data, (5) the local first model data and the local second model data, (6) the remote first model data and the local first model data, and (7) the remote second model data and the local second model data.

A communications link is supported by the remote wireless communications device 34 and the mobile wireless communications device 54. The above communications link supports synchronization or alignment of the foregoing data. If the communications link is disrupted or not reliable (e.g., because of poor or inadequate reception, propagation, or interference), the vehicle electronics 44, on-board vehicle controller 66 and the obstacle detector/avoidance module 64 may use the then current or latest update of the local first model data 58, the local second model data 60, and the local discrepancy data 62 to establish the current virtual environment or control the vehicle. However, the obstacle detector/avoidance module 64 may be programmed to override the vehicle virtual environment in response to real-time sensor data (from the first sensor 46, the second sensor 48, or both) that indicates that an obstacle is present, stationary or in motion, even if inconsistent with the latest update to the vehicle virtual environment.

The delay from the communications link (between the remote wireless communications device 34 and the mobile wireless communications device 54) includes propagation time, transmitter delay, and receiver delay (e.g., from detecting, decoding or demodulation of the received signal). The delay from the communications link is less critical to operation of the vehicle than in a conventional tele-operation or remote control environment because the vehicle can operate reliably without the communications link (e.g., remote wireless communications device 34 and the mobile wireless communications device 54) and because the operator may enter commands to the vehicle prior to when the vehicle needs to execute them to accomplish successfully a mission. To the extent that the virtual environment is generally known and is accurate with discrepancies reduced or eliminated, via the remote user interface 10, the operator can enter commands to the vehicle electronics 44 in advance of when the vehicle actually executes them in real time.

Discrepancy data exists where there are differences between the actual environment (e.g., real world environment) and the virtual environment (e.g., modeled environment) that is displayed to the operator at the remote user interface 10. The alignment, registration or faithfulness between the actual environment and the virtual environment (e.g., modeled environment) may affect the performance and behavior of the vehicle or the ability of the vehicle to conduct successfully a mission or complete a task. The remote data processor 16 and the remote user interface 10 cooperate to allow the operator to align, synchronize, and register the virtual environment to accurately, timely depict the actual environment for machine perception, navigation and control of the vehicle.

Discrepancies between the actual environment and the virtual environment may exist where the actual environment has changed over time and the virtual environment has not been updated. In one example, if the real world environment comprises a mine, where a tunnel has been recently closed for repair, the virtual environment should be updated so that the vehicle does not attempt to travel into the closed tunnel or can respond appropriately. In another example, an object (e.g., another vehicle) may change its position or enter into the actual environment. In such a case, the virtual environment should be updated to avoid a collision with the object or other vehicle, for instance. In yet another example, a discrepancy between the model data (for the virtual environment) and the corresponding real world data (for the actual environment) exists where vehicle is used to move or manipulate material in the real world and the quantity of moved material differs from that of the real world environment.

To resolve discrepancies, the manual discrepancy resolution module 24 assists the operator to manually add, delete or edit objects or geometric representations in the virtual environment such that the virtual environment more accurately represents the actual environment. Further, the manual discrepancy resolution module 24 may support tagging or identifying objects or geometric representations with names or other designators to assist the operator in controlling or monitoring the vehicle from the remote user interface 10. The tag or identifier may represent a classification of an object, as an animal, a person, a tree, a building, another vehicle, a telephone pole, a tower, or a road. Such tags or identifiers may be displayed or hidden from the view of the operator on the display 12 in the virtual environment, for example. In one embodiment, the discrepancy resolution module 24 may display 12 a cloud point or cluster to an operator and let the operator classify the cloud point or adopt or ratify a tentative classification of a classifier 22.

The vehicle electronics 44 comprises a location-determining receiver 67 (e.g., Global positioning system receiver with a differential correction receiver). The location-determining receiver 67 is mounted on the vehicle to provide location data or actual vehicular position data (e.g., coordinates) for the vehicle. The modeled vehicular position in the virtual environment is generally spatially and temporally aligned with the actual vehicular position in the actual environment at regular or periodic intervals via the communications link (e.g., the remote wireless communications device 34 and the mobile wireless communications device 54 collectively). The virtual environment may have a coordinate system with an origin or another reference position. The virtual vehicular position in the modeled or virtual environment may be tracked with reference to the origin or the reference position.

The remote data processor 16, the vehicle electronics 44 or both may cooperate with the location-determining receiver 67 to track which cells or areas in the work vehicle have been traversed by the vehicle and when those cells were traversed safely. A historical traversal record may include coordinates of traversed cells, identifiers associated with traversed cells, and time and date of traversal, for example. Sensor data collected from the perspective of each cell may also be stored for reference and associated with or linked to the historical traversal record. The historical traversal record and collected sensor data may be used to control the future behavior of the vehicle. For example, the historical traversal record and the collected sensor data may be used to establish a maximum safe speed for the vehicle for each corresponding cell of the virtual environment.

In one embodiment, if the communications link between the remote wireless communications device 34 and the mobile wireless communications device 54 is disrupted, fails, or is otherwise unreliable, the vehicle electronics 44 may stop or pause the motion of the vehicle, until the communications link between the wireless communication devices (34, 54) is restored or adequately reliable.

FIG. 2 is a diagram of one illustrative example of a remote user interface 10. As shown in FIG. 2, the remote user interface 10 has a group of display surfaces (e.g., generally planar surfaces) that intersect each other to form a generally polygonal structure with an interior 210. A user or operator may enter, occupy or observe the interior 210 in which images or displayed or projected on the display surfaces (200, 204, 206, and 202). The user may have a remote command interface 14 to control the vehicle, the vehicle electronics 44 or its operation, or to interact with the virtual environment, the actual environment, or both.

The display surfaces comprise a first display surface 200, a second display surface 204, a third display surface 206, and a fourth display surface 202. A projector may be associated with each display surface for projecting or displaying an image of the virtual environment on its corresponding display surface. Here, the projectors comprise a first projector 201 associated with the first display surface 200; a second projector 205 associated with the second display surface 204; a third projector 207 associated with the third display surface 206, and a fourth projector 203 associated with the fourth display surface 202.

In an alternative embodiment, the display surfaces may comprise flat panel displays, liquid crystal displays, plasma displays, light emitting diode displays, or otherwise for displaying images in the virtual environment. For example, although the remote interface 10 of FIG. 2 may comprise what is sometimes referred to as a multi-wall CAVE (computer automated virtual environment), in an alternative embodiment the remote interface 10 may comprise a single wall display, a head-mounted display, or a desktop three dimensional liquid crystal or plasma display device.

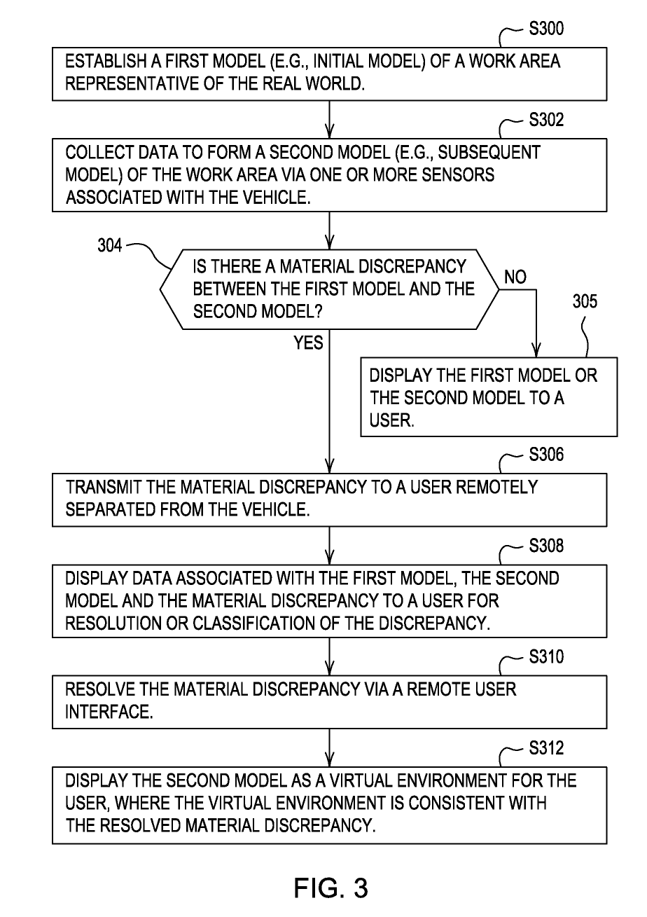

FIG. 3 illustrates a method for remotely monitoring and controlling a vehicle via a virtual environment. A previously noted, a virtual environment refers to a representation of the vehicle in its actual environment from one or more perspective or coordinate reference frames. The virtual environment may comprise a representation of the real world that is displayed to user or operator to facilitate control and/or monitoring of the vehicle. The method of FIG. 3 begins in step S300.

In step S300, a first model (e.g., initial model) of a work area representative of the real world is established. The first model may be established in accordance with various techniques that may be applied individually or cumulatively. Under a first technique, the first model is established by conducting a survey of the work area prior to engaging in management or control of the vehicle via a remote user interface 10. Under a second technique, the first model is established by conducting a survey of the work area periodically or at regular intervals to update the first model prior to engaging in management or control of the vehicle via a remote user interface 10. Under a third technique, a first sensor 46 (e.g., imaging unit) and a second sensor 48 (e.g., laser range finder) collect sensor data for establishing a first model of a work area representative of the real world. Under a fourth technique, vehicle electronics 44 establishes a first model of the work area based on collected sensor data. Under a fifth technique, the first model comprises an a priori three dimensional representation of the work area.

The first model may comprise occupancy grids of the work area, where each grid is divided into a number of cells. Each cell may be rectangular, cubic, hexagonal, polygonal, polyhedral or otherwise shaped, for example. Each cell may have a state which indicates whether the cell is occupied by an object or empty or the probability that the cell is occupied by an object or the probability the cell is empty. In one embodiment, the occupancy grid is expressed in three dimensions (e.g., depth, height, and width). The occupancy grid may vary over time, which may be considered a fourth dimension.

In one embodiment, a cell of the occupancy grid may be associated with one or more pixels or voxels that define an object or a portion of an object within the cell. The pixels may represent color data, intensity data, hue data, saturation data, or other data for displaying an image representative of the environment.

In step S302, data is collected to form a second model (e.g., candidate model) of the work area via one or more sensors (e.g., first sensor 46 and second sensor 48) associated with the work vehicle. For example, the first sensor 46, the second sensor 48 or both, may collect a second model of the work area that is in a similar or comparable format to the first model. If the second model is not in the same or similar format as the first model, the collected data of the second model may be revised or converted into a suitable format for comparison to or merging with that of the first model. In one illustrative embodiment, the second model is a collected three dimensional representation of the work area.

In step S304, an evaluator 52 determines if there is a material discrepancy between the first model and the second model. If there is a material discrepancy between the first model and the second model, the method continues with step S306. However, if there is no material discrepancy between the first model and the second model, the method continues with step S305.

In step S306, the evaluator 52 may determine that there is a material discrepancy where: (1) the first sensor 46 or the second sensor 48 detects an object or obstacle in the second model that does not exist in the first model; (2) an identifier 20 identified an object, but a classifier 22 is unable to reliably classify the object into a classification (e.g., tree, a person, fence, a tractor, a bush, an animal or a building); (3) a classifier 22 is inactive to allow a user to classify objects manually in the image data; or (4) other conditions or factors are present that are indicative of a material discrepancy. In one embodiment, the material discrepancy comprises a cloud point or a portion of the collected three dimensional representation (e.g., of the second model) that materially differs from the a priori three dimensional representation (e.g., of the first model).

In step S306, the vehicle electronics 44 or mobile wireless device transmits the material discrepancy to a user remotely separated from the vehicle. For example, the mobile wireless communications device 54 transmits the material discrepancy to the remote wireless communications device (e.g., transceiver). The remote wireless communications device 34 receives the transmission of the material discrepancy and routes it to the manual discrepancy module 24.

In step S305, the remote data processor 16 or the remote user interface 10 displays the first model or the second model to a user. The first model data, the second model data, or both are transmitted to the remote wireless communications device 34 from the mobile wireless communications device 54, to the extent necessary to provide the appropriate model data to the user at the remote user interface 10.

In step S308, the manual discrepancy module 24 or remote data processor 16 facilitates display on the display 12 of data associated with the first model, the second model, and the material discrepancy to a user for resolution or classification of the discrepancy.

In step S310, the manual discrepancy module 24 or the remote data processor 16 resolves the material discrepancy via a remote user interface 10 or the remote command interface 14. The user may resolve the discrepancy via the manual discrepancy module 24 or the remote command interface 14, while the discrepancy is displayed via the remote user interface 10. Further, the user may resolve the material discrepancy in accordance with one or more of the following techniques, which may be applied alternately or cumulatively.

Under a first technique, the user may resolve the material discrepancy via the manual discrepancy resolution module 24 or the remote command interface 14 by adding, deleting, or editing user-definable zones, user-definable volumes or user-selected objects in at least one of the first model and the second model to obtain a virtual environment. The zones or volumes may be defined by groups of pixels, voxels, or their respective coordinates.

Under a second technique, via the remote command interface 14, the manual discrepancy resolution module 24, or the classifier 22, the user may resolve a material discrepancy by classifying one or more potential obstacles as one or more actual obstacles if the discrepancy data conforms to a representative obstacles in at least one of size, dimension, shape, texture, color, or any group of the foregoing parameters.

Under a third technique, if the discrepancy relates to an unclassified object or obstacle displayed to a user via the remote user interface 10, the user may manually classify the object into an appropriate classification via the remote command interface 14, the manual discrepancy resolution module 24, or the classifier 22 based upon the user's judgment or analysis of various sensor data (e.g., that of the first sensor 46 and the second sensor 48).

Under a fourth technique, if the discrepancy relates to duplicate objects or artifacts, or other erroneous obstacles that appear in the first model or the second model, via the remote command interface 14 or the manual discrepancy resolution module 24 the user may delete the erroneous obstacles or artifacts that do not exist or no longer exist in the real word based on an actual survey of the real world, satellite imagery, surveillance images, or images from other vehicles that communicate with the remote user interface 10.

Under a fifth technique, if the discrepancy relates to an unidentified or unclassified object, via the remote command interface 14, the manual discrepancy resolution module 24, or the augmenter 26, the user may augment, tag or label images or a portion of images (e.g., displayed to a user) via the display 12 in the first model or second model to assist in control or monitoring of the vehicle. The remote user interface 10 can display the first model or second model representative of the virtual environment in a mode in which objects are augmented with textual labels or bubbles with descriptive text. For example, the manual discrepancy resolution module allows the user to tag items in the second model with identifiers (e.g., tree, building, rock, stump, road, culvert, ditch, chemical drums, seed, supplies, abandoned equipment), text, alphanumeric characters, symbols, or other augmented information.

To prevent certain material discrepancies from arising in the first place, the remote data processor 16 may: (1) update the first model to reflect changes in the real world; (2) update the second model to be consistent with or synchronized to the first model; (3) rely on an automated classifier 22 for preliminary or final classification and selectively, manually screen those classifications in which confidence level or reliability tends to be lower than a minimum threshold; and (4) take other preventative measures to resolve potential ambiguities or differences in data in the first model and second model.

In step S312, the display module 28 displays the second model (or the first model) as the virtual environment for the user, where the virtual environment is consistent with the resolved material discrepancy. Step S312 may be carried out by displaying the second model (or the first model) as the virtual environment from virtually any perspective for which data is available. Under one example, the remote user interface 10 displays the collected three dimensional representation of the virtual environment from a perspective above and behind an actual position of the vehicle. Under another example, the remote user interface 10 displays a collected three dimensional representation of the virtual environment from a perspective aboard the vehicle.

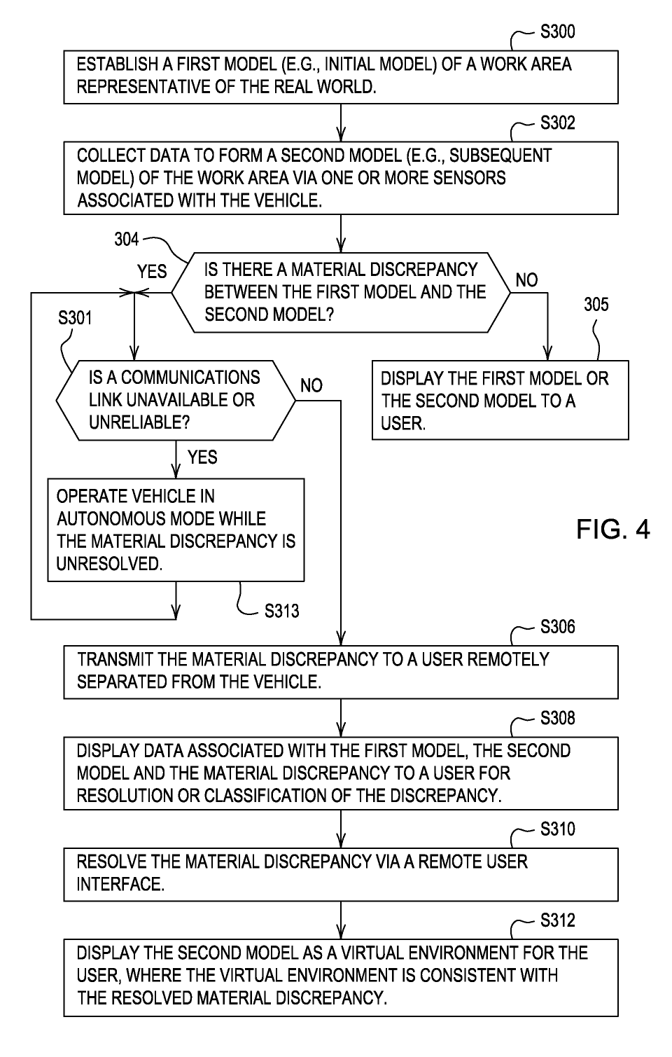

The method of FIG. 4 is similar to the method of FIG. 3, except the method of FIG. 4 further comprises steps S311 and S313. Like reference numbers in FIG. 3 and FIG. 4 indicate like elements.

In step S304, it is determined whether there is a material discrepancy between the first model and the second model. If there is a material discrepancy, the method continues with step S311. However, if there is not a material discrepancy, the method continues with step S313.

In step S311, the local data processor 50 or the mobile wireless communications device 54 determines if a communications link to the remote wireless communications device 334 is unavailable or unreliable. Unavailable means that the communications link is not operational because of signal propagation, reception, jamming, defective equipment, inadequate electrical energy (e.g., dead batteries), technical reasons, or other issues. Unreliable means that the communications link does not offer a sufficiently high level of service, a signal of sufficiently high quality (e.g., signal, or a sufficient low bit error rate for the transmission of data, or otherwise does not support the reliable transmission or reception of data between the remote wireless communications device 34 and the mobile wireless communications device 54.

In step S313, the vehicle electronics 44 operates the vehicle in an autonomous mode while the material discrepancy is unresolved. An autonomous mode refers to any mode where (a) the vehicle operates primarily or exclusively under the direction of the vehicle electronics 44 without material assistance for the user or the remote data processor 16 or (b) the vehicle or vehicle electronics 44 operates based on a pre-programmed mission, algorithm, plan, path or otherwise without material assistance from the user. Once a discrepancy is detected, but not yet resolved by a user via the remote user interface 10, the local data processor 50 and on-board vehicle controller 66 may operate in accordance with several distinct autonomous modes. Under a first mode, the obstacle detector/avoidance module 64 or the on-board vehicle controller 66 may stop movement or action and wait until the discrepancy is resolved manually by a user (e.g., via the remote user interface 10). Under a second mode, the obstacle detector/avoidance module 64 or the on-board vehicle controller 66 may create a quarantine zone or no-entry zone that contains the discrepancy and which the vehicle will not enter into the discrepancy is resolved. Under a third mode, the obstacle detector/avoidance module 64 or the on-board vehicle controller 66 may assign priority to its obstacle detector/avoidance module 64 over the manual discrepancy resolution module 24 to avoid delay that might otherwise occur in waiting for a user to resolve the discrepancy via the remote user interface 10 and the manual discrepancy resolution module 24. Under a fourth mode, the vehicle electronics 44 or the obstacle detector/avoidance module 64 may treat one or more unresolved discrepancies as a potential obstacle or obstacles to avoid colliding with the obstacles. Under a fifth mode, the local data processor 50, the on-board vehicle controller 66 or both control the vehicle upon a loss of communication with the remote user or upon a threshold delay for a user to receive a return acknowledgement in reply to an entered command or transmission of a command between the remote wireless communications device 34 and the local wireless communications device 54. A discrepancy may require the intervention of an operator or user to ultimately resolve it. After executing step S313, the vehicle may return to execute step S11.

If the communications link is unavailable or unreliable in step S311, the method continues with step S306. The communications link may be considered unavailable upon the loss of communication with a remote user that is equal to or greater than a threshold time period. Alternatively, the communications link may be considered unavailable if the user is unable to communicate (or receive an acknowledgement from a command entered by the user via the remote command interface 14) between the remote wireless communications device 34 and the local wireless communications device 54 by more than a threshold delay period. In step S306, the mobile wireless communications device 54 transmits the material discrepancy to the remote wireless communications device 34 for resolution by the user via the remote user interface 10 as previously described more fully in conjunction with the method of FIG. 3.

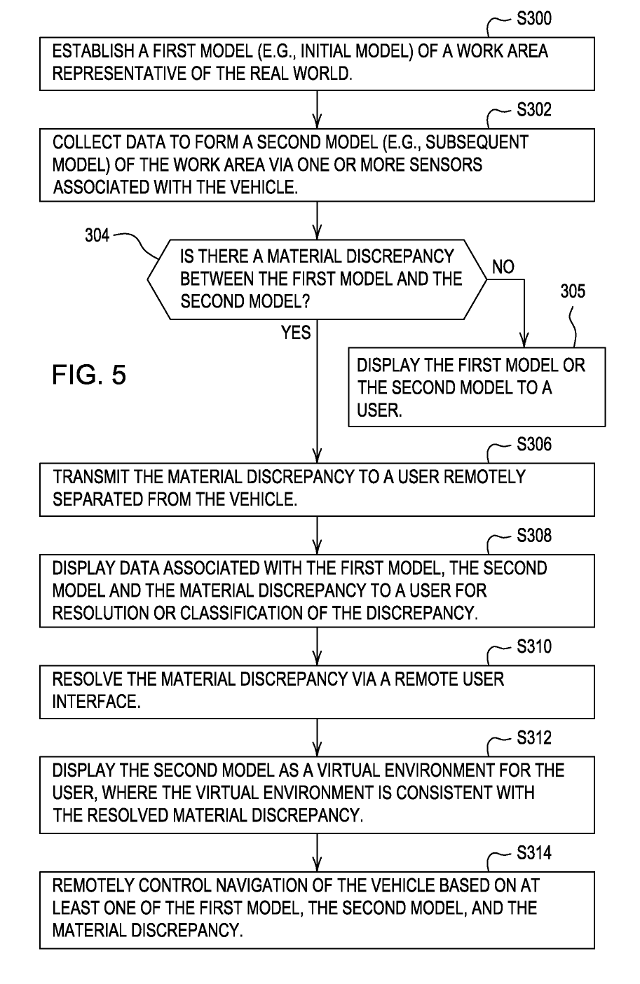

The method of FIG. 5 is similar to the method of FIG. 3, except the method of FIG. 5 further comprises step S314. Like reference numbers refer to like procedures or methods in FIG. 3 and FIG. 5.

Step S314 may be carried out after step S312, for example. In step S314, a user via the remote user interface 10 or the remote command interface 14 remotely controls navigation of the vehicle based on at least one of the first model, the second model, and the material discrepancy. In one embodiment, the user is able to enter or issue one or more advance commands prior to when the vehicle electronics 44 will execute the command or commands because the virtual environment is generally known or established (e.g., by a prior survey of the real world environment). In another embodiment, the user is able to enter a sequence of advance commands that form instructions, a mission, or a plan for the vehicle electronics 44 prior to when the vehicle electronics 44 will execute one or more components of the sequence because the virtual environment is generally known or established (e.g., by a prior survey of the real world environment).

The temporal impact of the propagation delay, transmission delay (e.g., coding or modulation delay), and/or reception delay (e.g., decoding or demodulation delay) is generally reduced, where the temporal impact is associated with the transmission and reception of a modulated electromagnetic signal from the remote user interface 10 to the vehicle electronics 44 via the remote wireless communications device and the local wireless communications device 54. The reduction of the temporal impact or issuing advance commands or sequences may be referred to as time-shifting or time-shifting commands. In one example of carrying out step S314, a user enters time-shifting commands at the remote user interface 10 such that the vehicle electronics 44 may receive one or more commands in advance of, or simultaneously with, transmitting observed information (from sensors 46, 48) to a user at the remote user interface 10. Once a series of time-shifted commands are received at the vehicle electronics 44, the delay between the remote user interface 10 and the vehicle electronics 44 becomes less critical to the vehicle's mission than the delay associated with a conventional tele-operated vehicle control environment, unless the user modifies the commands or needs to resolve a material discrepancy resolution. The time shifting and advance commands are executed subject to the obstacle detector/avoidance module 64 or other local control of the vehicle electronics 44 for safety, obstacle avoidance or other programmable reasons established by the user.

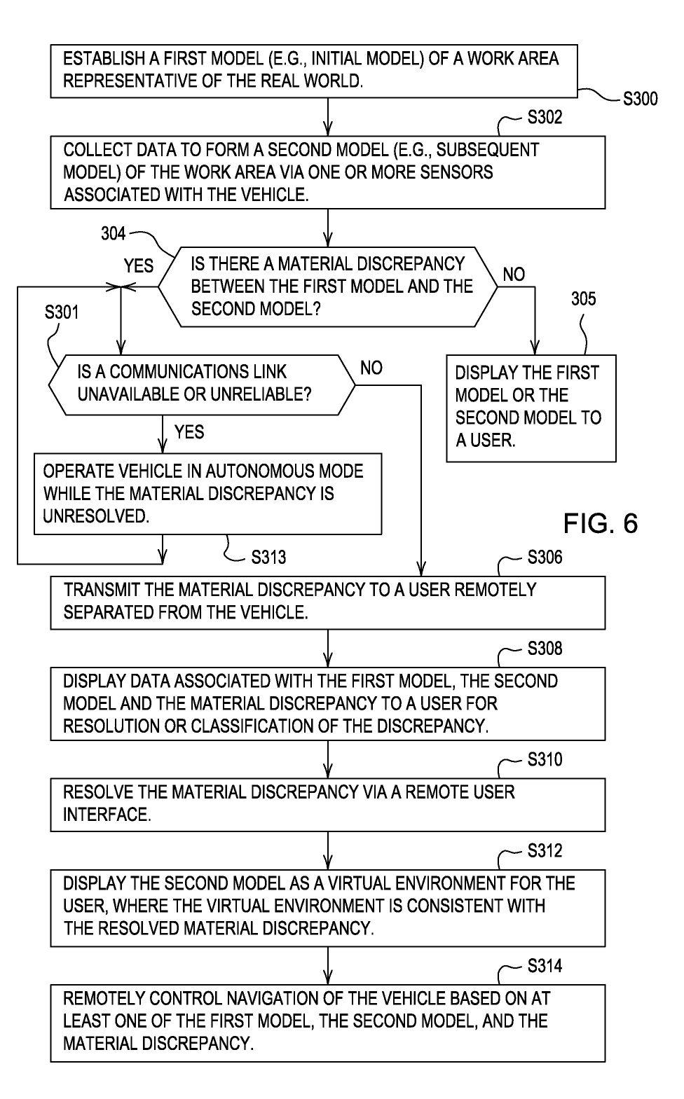

The method of FIG. 6 is similar to the method of FIG. 4, except the method of FIG. 6 further comprises step S314. Like reference numbers refer to like procedures or methods in FIG. 4 and FIG. 6.

Step S314 may be carried out after step S312, for example. In step S314, a user via the remote user interface 10 or the remote command interface 14 remotely controls navigation of the vehicle based on at least one of the first model, the second model, and the material discrepancy. In one embodiment, the user is able to enter or issue one or more advance commands prior to when the vehicle electronics 44 will execute the command or commands because the virtual environment is generally known or established (e.g., by a prior survey of the real world environment). In another embodiment, the user is able to enter a sequence of advance commands that form instructions, a mission, or a plan for the vehicle electronics 44 prior to when the vehicle electronics 44 will execute one or more components of the sequence because the virtual environment is generally known or established (e.g., by a prior survey of the real world environment).

The temporal impact of the propagation delay, transmission delay (e.g., coding or modulation delay), and/or reception delay (e.g., decoding or demodulation delay) is generally reduced, where the temporal impact is associated with the transmission and reception of a modulated electromagnetic signal from the remote user interface 10 to the vehicle electronics 44 via the remote wireless communications device and the local wireless communications device 54. The reduction of the temporal impact or issuing advance commands or sequences may be referred to as time-shifting or time-shifting commands. In one example of carrying out step S314, a user enters time-shifting commands at the remote user interface 10 such that the vehicle electronics 44 may receive one or more commands in advance of, or simultaneously with, transmitting observed information (from sensors 46, 48) to a user at the remote user interface 10. Once a series of time-shifted commands are received at the vehicle electronics 44, the delay between the remote user interface 10 and the vehicle electronics 44 becomes less critical to the vehicle's mission than the delay associated with a conventional tele-operated vehicle control environment, unless the user modifies the commands or needs to resolve a material discrepancy resolution. The time shifting and advance commands are executed subject to the obstacle detector/avoidance module 64 or other local control of the vehicle electronics 44 for safety, obstacle avoidance or other programmable reasons established by the user.

The method and system for monitoring or controlling a vehicle is well-suited for operation of work vehicles in dangerous or hazardous environments that might have negative impact on the health or welfare of human operators. For example, operator may remotely control the work vehicle from a virtual environment, while the vehicle actually operates in harms way in the actual environment, such as a mine, a battlefield, a hazardous waste site, a nuclear reactor, an environmental remediation site, a toxic chemical disposal site, a biohazard area, or the like.

Having described the preferred embodiment, it will become apparent that various modifications can be made without departing from the scope of the invention as defined in the accompanying claims.

The following is claimed:

1. A method for remotely monitoring and controlling a vehicle, the method comprising:
establishing a first model of a work area representative of the real world;
collecting data on a second model of the work area via one or more sensors associated with the vehicle;
determining a material discrepancy between the first model and the second model;
transmitting the material discrepancy to a user remotely separated from the vehicle; and
displaying data from the first model, the second model and the material discrepancy to a user for resolution or classification of the discrepancy.

2. The method according to claim 1 further comprising:
resolving the material discrepancy via a remote user interface by adding, deleting, or editing at least one of an object or a zone of the first model and the second model to obtain a virtual environment.

3. The method according to claim 2 further comprising:
displaying the virtual environment for a user, where the virtual environment is consistent with the resolved material discrepancy and where the virtual environment is displayed from a perspective above and behind the direction of travel of the vehicle.

4. The method according to claim 1 further comprising:
operating the vehicle in an autonomous mode while the material discrepancy is unresolved.

5. The method according to claim 1 further comprising:
supporting remotely controlling navigation of the vehicle based on at least one of the first model, the second model and the material discrepancy.

6. The method according to claim 1 further comprising:
identifying potential obstacles as differences between the first model and second model; and
classifying the potential obstacles as actual obstacles if the discrepancy data conforms to representative obstacle data in at least one of size, dimension, shape, texture and color.

7. The method according to claim 1 further comprising:
controlling the vehicle upon loss of communication with the a remote user or upon a preestablished delay for a user to enter a command or transmit a navigation command to the vehicle.

8. The method according to claim 1 further comprising:
treating an unresolved discrepancy as a potential obstacle and avoiding colliding with the potential obstacle.

9. The method according to claim 1 further comprising:
entering an advance command at the remote user interface such that the vehicle may receive one or more commands in advance of or simultaneously with transmitting observed information to a user at the remote user interface.

10. The method according to claim 1 further comprising:
allowing the user to tag items in the second model with identifiers or augmented information.

11. The method according to claim 1 further comprising:
resolving the material discrepancy by classifying the material discrepancy within a suitable classification based on a user's evaluation of one or more parameters.

12. A system for remotely monitoring and controlling a vehicle, the system comprising:
a user interface for establishing a first model of a work area representative of the real world;
a plurality of sensors for collecting data on a second model of the work area, each of the sensors associated with the vehicle;
an evaluator for determining a material discrepancy between the first model and the second model;
a transmitter for transmitting the material discrepancy to a user remotely separated from the vehicle; and
a display module for displaying data from the first model, the second model and the material discrepancy to a user for resolution or classification of the discrepancy.

13. The system according to claim 12 further comprising:
a discrepancy resolution module for resolving the material discrepancy via a remote user interface by adding, deleting, or editing at least one of an object or a zone of the first model and the second model to obtain a virtual environment.

14. The system according to claim 13 wherein the display module is arranged to display the virtual environment for a user, where the virtual environment is consistent with the resolved material discrepancy and where the virtual environment is displayed from a perspective above and behind the direction of travel of the vehicle.

15. The system according to claim 12 further comprising:
an on-board controller for operating the vehicle in an autonomous mode while the material discrepancy is unresolved.

16. The system according to claim 12 further comprising:
a remote control interface for supporting remotely controlling navigation of the vehicle based on at least one of the first model, the second model and the material discrepancy to a user for resolution or classification of the discrepancy.

17. The system according to claim 12 further comprising:
an identifier for identifying potential obstacles as differences between the first model and second model;
a classifier for classifying the potential obstacles as actual obstacles if the discrepancy data conforms to representative obstacle data in at least one of size, dimension, shape, texture and color.

18. The system according to claim 12 further comprising:
an onboard vehicle controller for controlling the vehicle upon loss of communication with the a remote user or upon a preestablished delay for a user to enter a command or transmit a navigation command to the vehicle.

19. The system according to claim 12 further comprising:
an obstacle detector for treating an unresolved discrepancy as a potential obstacle and avoiding colliding with the potential obstacle.

20. The system according to claim 12 further comprising:
a command module for applying a queue of one or more entered commands entered at the remote user interface such that the vehicle may act upon one or more entered commands in advance of or simultaneously with transmitting or receipt of observed information from executed commands to a user at the remote user interface.

21. The system according to claim 12 further comprising:
an augmentation module for allowing the user to tag items in the second model with identifiers or augmented information.

22. The system according to claim 12 further comprising:
a classifier for resolving the material discrepancy by classifying the material discrepancy within a suitable classification based on a user's evaluation of one or more parameters.
